(19) United States
(12) Patent Application Publication
(10) Pub. No.: US 2019/0027260 A1
(43) Pub. Date: Jan. 24, 2019

(54) ENERGY GENERATION

(71) Applicant: Frank WOODBINE, Ynyslas, Borth Dyfed (GB)

(72) Inventor: Frank WOODBINE, Ynyslas, Borth Dyfed (GB)

(21) Appl. No.: 16/068,952

(22) PCT Filed: Dec. 5, 2016
(86) PCT No.: PCT/GB2016/053819

§ 371 Date: Jul. 10, 2018

(30) Foreign Application Priority Data
Jan. 12, 2016 (GB) 1600585.2

(51) Int. Cl. G21B 3/00; F42B 5/16; G21D 7/00

(52) U.S. Cl. CPC G21B 3/006; G21D 7/00; F42B 5/16

(57) ABSTRACT

The present invention provides an apparatus for generating energy suitable for use in an electrical power station. The apparatus comprises a quench chamber, the chamber quench chamber containing a quench fluid, the quench chamber having a fuel inlet and an outlet in fluid communication with at least one turbine of the power station, a target located within the quench chamber, and a propulsion means operable to propel a projectile towards the target. The projectile comprises a shaped charge comprising a charge liner having a front portion and a rear portion, an explosive material located adjacent to at least the rear portion of the charge liner and a detonator operable to detonate the explosive material. In use, the propulsion means propels the projectile through the fuel inlet towards the target and, before the projectile reaches the target, the detonator detonates the explosive material generating a jet of particles which impacts the target, thereby releasing energy, which heats the quench fluid causing a gas to be released through the outlet, which gas then drives the at least one turbine.

The present invention relates to systems and methods for generating energy. In particular, the present invention provides an improved system and method for generating electrical energy.

It is commonly accepted that burning fossil fuels (e.g. oil, coal or natural gas) in conventional power stations to generate energy is unsustainable, due to the Earth's finite supply of fossil fuel materials. It is also widely accepted that burning fossil fuels is harmful to the environment, as it releases greenhouse gasses into the atmosphere, which contribute to global warming. However, there is an ever-increasing demand for energy caused by increasing populations, globalisation and increasing industrialisation (particularly in emerging economies such as China or India).

The development of renewable energy sources has often been proposed as a solution to this impending energy crisis. However, renewable energy sources such as solar power, tidal power or wind power are inherently intermittent. Harnessing this energy can therefore be difficult due to inefficiencies in storing the energy and converting the input energy into electrical output energy.

An alternative form of sustainable energy generation is nuclear power, e.g. nuclear fission or nuclear fusion power. Nuclear fission is the splitting of a large (or heavy) nucleus into two or more smaller nuclei and nuclear fusion is the binding of two or more small (or light) nuclei to form a larger (or heavier) nucleus. The energy released by these reactions is the difference in binding energies between the reactant(s) and the product(s).

Commercial nuclear fission reactors have been in use since the 1950s. Typically, the heat released by the nuclear fission reaction is used to operate a steam turbine that drives electrical generators, as in conventional power stations. Although not a renewable energy source, nuclear fission reactors now provide relatively safe, reliable and clean energy compared to fossil fuel plants. However, nuclear fission generates by-products which include several long-lived radioactive isotopes, commonly referred to as nuclear waste, which can be extremely dangerous. For example, if a person were exposed to unshielded, unprocessed nuclear waste, they could develop acute radiation sickness, which can be lethal. How to safely process or store nuclear waste is a controversial issue which affects the feasibility and popularity of nuclear power.

More recently, there has been a drive to realise an efficient, commercial nuclear fusion power station. In comparison with nuclear fission, nuclear fusion reactions create a lot less harmful nuclear waste. Nuclear fusion also has the potential to provide more output energy for a given weight of fuel than any fuel-consuming energy source currently in use. Of course, the Sun is an example of a natural fusion reactor which generates enough energy to heat the Earth. However, man-made nuclear fusion reactors are not currently commercially viable. This is because they require vast quantities of input energy, which is expensive, and only stay ignited for fractions of a second, consuming more energy than is input.

For example, in magnetic confinement reactors (such as tokamak reactors like ITER or JET) very strong electromagnetic fields confine fusion fuel in a plasma at temperatures and pressures which are high enough to ignite fusion. Conversely, in inertial confinement nuclear fusion reactors (such as at NIF) very high energy lasers are fired at a compressed pellet of fusion fuel which creates a shockwave that compresses the fuel to temperatures and pressures at which nuclear fusion is ignited.

There remains, however, a need for improved, sustainable energy generation.

In a first aspect, the present invention provides an apparatus for generating energy suitable for use in an electrical power station, comprising:
a quench chamber, the quench chamber containing a quench fluid, the quench chamber having a fuel inlet and an outlet in fluid communication with at least one turbine of the power station;
a target located within the quench chamber; and
a propulsion means operable to propel a projectile towards the target;
wherein the projectile comprises a shaped charge comprising a charge liner having a front portion and a rear portion, an explosive material located adjacent to at least the rear portion of the charge liner and a detonator operable to detonate the explosive material;
wherein, in use, the propulsion means propels the projectile through the fuel inlet towards the target and, before the projectile reaches the target, the detonator detonates the explosive material generating a jet of particles which impacts the target, thereby releasing energy, which heats the quench fluid causing a gas to be released through the outlet, which gas then drives the at least one turbine.

In some embodiments, the projectile may comprise a plurality of detonators.

The narrowest part of the charge liner may be disposed adjacent to the detonator(s).

Optionally, the charge liner may be a conical charge liner. The detonator(s) may be disposed proximate the apex of the conical charge liner.

When the explosive material in the shaped charge is detonated from the rear, a very high-pressure shockwave is generated. The energy of the shockwave is, due to the shaping of the charge liner, concentrated in the hollow cavity and charge liner. This pressure forces the charge liner inwards to collapse upon its central axis. As the walls of the charge liner collide with each other the force of the collision causes the charge liner material to form a high-velocity jet of particles projected forwards (i.e. towards the target), typically along the central axis of the liner, which jet of particles acts as a hydrodynamic fluid.

Typically, most of the jet material may originate from the innermost part of the charge liner, wherein the innermost part typically comprises a layer of about 10% to 20% of the thickness of the charge liner. The rest of the charge liner usually forms a slower-moving slug of material that follows the jet. The front tip of the jet can move at speeds of between 7000 to 14000 m/s, the jet tail at a lower velocity (around 1000 to 3000 m/s). The exact velocities depend on many factors, such as the charge's shape, type of explosive material, and the type of detonator used.

The jet formed by the charge liner is directed towards the target and, due to the extremely high momentum and energy of the jet particles, the target material is forced to the sides of the jet stream, thereby creating a hole or puncture in the target. This is commonly known as the Munroe effect. It has been demonstrated that shaped charges can penetrate a steel plate as thick as 150% to 700% of the diameter of the shaped charge. For example, during the 1940s a shaped charge anti-tank gun was capable of penetrating in excess of 200 mm of tank armour.

In an embodiment, the high-speed jet formed by the charge liner may pass through at least a portion of the quench fluid in the quench chamber before contacting the target. The jet will transfer some kinetic energy to the quench fluid, causing it to at least partially boil, and a gas to be emitted through the outlet. This gas may then turn the turbines of a power station, which could in turn drive an electric generator.

In addition, when the jet impacts the target more heat will be released to the quench fluid in the quench chamber, causing more gas to be emitted through the outlet.

Thus, the present invention provides a system for generating energy which is environmentally friendly, as it does not use fossil fuels, release harmful gases into the atmosphere, and/or produce radioactive waste by-products. Whilst not a renewable energy source, the system of the present invention is potentially sustainable, as the resources required to manufacture the charge liner and explosive material etc. are relatively abundant.

In some embodiments, the front portion of the charge liner may be shaped aerodynamically. For example, the front portion of the charge liner may comprise a tip and the diameter of the front portion of the charge liner may increase from the tip backwards. The diameter of the rear portion of the charge liner may decrease along its length.

Optionally, the projectile may comprise an elongate member having a first end and a second end. The shaped charge may be connected to the first end of the elongate member. The propulsion means may be operable to apply a force to the second end of the elongate member to propel the projectile. In some embodiments, the elongate member may comprise one or more stabilising fins, e.g. two, three or four stabilising fins or at least one pair of stabilising fins.

Optionally, the quench fluid may comprise, or consist essentially of, water, such that when the fluid is heated steam is generated, which is emitted through the outlet towards the turbine(s) of the power station. The quench chamber may be at least partially evacuated, i.e. the pressure in the quench chamber may be lowered by at least partially removing the air in the chamber, thereby lowering the boiling temperature of the quench fluid and increasing the output of steam or other gasses emitted when the fluid is heated.

In some embodiments, the quench chamber may comprise more than one outlet in fluid communication with the at least one turbine of the power station.

The quench chamber may comprise an emergency outlet in fluid communication with an expansion chamber. The emergency outlet may be configured to allow quench fluid from the quench chamber to flow into an expansion chamber if the pressure in the quench chamber exceeds a predetermined value, thereby preventing the quench chamber from being damaged. For example, the emergency outlet may comprise a bursting disc configured to rupture when the pressure in the quench chamber reaches a maximum safety threshold.

In some embodiments, the propulsion means may comprise a chemical propellant or a magnetic or electrical propulsion means. For example, the propulsion means may comprise a launch tube configured to receive the projectile and a chemical propellant disposed proximate the rear end of the shaped charge or the second end of the elongate member. When the chemical propellant is ignited it may generate a thrust which propels the projectile through the launch tube, through the fuel inlet and into the quench chamber. The chemical propellant may be a solid or a liquid propellant.

The propulsion means may pass through and be sealed within the fuel inlet.

Optionally, the propulsion means may comprise a type of artillery or gun barrel. For example, the propulsion means may comprise a chamber configured to receive the projectile, a liner substantially surrounding the chamber, a sealing collar and an outer jacket. This arrangement may prevent any back-blast of pressure from launching the projectile causing any structural damage to the fuel inlet.

The explosive material in the shaped charge may be solid, liquid or gaseous. In some embodiments, the explosive material may at least partially comprise Octogen (HMX) and a plastic binder, thereby forming a polymer-bonded explosive material (PMX). Optionally, the explosive material may comprise a highly sensitive explosive material together with a less sensitive explosive material. For example, the explosive material may at least partially comprise Octol (a composition of Octogen and TNT) and/or Amatol. Optionally, the explosive material may at least partially comprise an explosive nitroamine and/or powdered aluminium.

In some embodiments, the charge liner may be formed of one or more of copper, tungsten, tantalum and/or molybdenum. Optionally, the or an internal apex angle of the rear portion of the charge liner, e.g. the conical charge liner, may be at least 40° and/or less than 90°.

Optionally, the target may be formed of one or more of steel, iron, titanium or another metal suitable for use in armour plating. The average thickness of the target may be selected such that the target is sufficiently thick to prevent the jet stream formed by the charge liner from completely penetrating the target and consequently impacting one or more walls of the quench chamber. Optionally, the target may have a thickness of at least 400 mm, or at least 800 mm.

In some embodiments, the quench chamber may comprise one or more walls. At least a portion of the one or more walls may be formed of steel, iron or titanium and have a thickness of at least 200 mm. The one or more walls may be thickest in the region most likely to be impacted by a deflected jet formed by the charge liner, or a jet which has passed though the target. This reinforcement may prevent the wall(s) of the quench chamber from being perforated.

Optionally, the quench chamber may comprise at least one outer wall. The at least one outer wall may substantially surround the quench fluid. The at least one outer wall may be configured to withstand thermal shock and/or store heat with minimum losses. For example, the at least one outer wall may comprise concrete.

In some embodiments, the or a hollow cavity within the charge liner may be filled with air at standard temperature and pressure.

In some embodiments, the charge liner may be at least partially filled by a pressurised fluid. It may be advantageous to pressurise the fluid in the charge liner as, when the walls of the charge liner collapse inwards, they will exert a high pressure on the already pressurised fluid which is trapped in the jet stream formed by the charge liner. Any fluid trapped between the target and the jet stream will also be further pressurised as the jet impacts the target. This may greatly increase the amount of heat transferred to the quench fluid, thereby increasing the amount of energy generated.

In some embodiments, the charge liner may be at least partially filled by a fusion fuel (i.e. a fuel used in nuclear fusion reactors). For example, the charge liner may at least partially comprise deuterium-tritium (D-T), helium, helium-deuterium and/or lithium deuteride (⁶LiD). In some embodiments the pressure exerted by the collapsing charge liner and the impact between the jet formed by the liner and the target may be sufficient to ignite nuclear fusion of the fusion fuel. Optionally, the fusion fuel may be pressurised when inserted into the charge liner.

For example, the pressure exerted by the jet formed by a charge liner using Amatol-based explosive materials as it impacts a target can exceed 10 million kg/cm². More advanced, modern explosive materials, such as Octogen or Octol may exceed a greater pressure than 10 million kg/cm², which may be sufficient for some of the nuclei in the fusion fuel to fuse. Igniting nuclear fusion, however briefly, would significantly increase the amount of energy transferred to the quench fluid, mostly in the form of neutrons emitted during fusion, and thus the amount of energy generated may be significantly increased.

Thus, the present invention may be capable of igniting nuclear fusion using only a projectile comprising a shaped charge, without requiring vast amounts of input energy in the forms of lasers or magnetic fields as required in known inertial or magnetic confinement fusion reactors. Instead, the configuration of the shaped charge may be sufficient to confine the fusion plasma created by the collapsing charge liner long enough for fusion to occur.

The initial pressure of the fusion fuel may be as high as can be withstood by the charge liner without compromising structural integrity. This depends on the shape, material and construction of the charge liner. Optionally, the fusion fuel may be contained within a separate pressurised vessel within the charge liner.

Optionally, a fuel rod may be connected to the front portion of the charge liner, wherein the fuel rod comprises a cavity configured to receive a fusion fuel. In an embodiment, the fuel rod may comprise a metal, e.g. steel, rod drilled in its centre to form the cavity. Optionally, the fuel rod may have a length of up to or at least 100 mm, up to or at least 200 mm and/or up to or at least 400 mm. The cavity may have a length of up to 200 mm or up to 100 mm.

The fuel rod may have a diameter slightly larger than the tip of the front portion of the charge liner. Preferably, the centre of the cavity in the fuel rod may be aligned with a central, longitudinal axis of the front portion of the charge liner. This may ensure that the fusion fuel contained in the fuel rod is pressurised by the jet formed by the collapsed charge liner. This should also ensure that, in use, the fuel rod is positioned between the jet stream and the target.

Either or both of the charge liner and the fuel rod may contain a fusion fuel.

Optionally, the fusion fuel in the fuel rod may be different from the fusion fuel contained in the charge liner. For example, in some embodiments the cavity in the fuel rod may not be in fluid communication with the cavity formed in the hollow charge liner, keeping the fusion fuels separate. The fuel rod may act as a booster fuel to increase the energy (including heat) released by the shaped charge upon impact with the target and/or upon detonation of the explosive material.

In some embodiments, the cavity in the fuel rod may at least partially contain a pressurised lithium deuteride (⁶LiD) based fuel and the charge liner may at least partially comprise a pressurised deuterium-tritium based fuel. This combination of fuels may be particularly advantageous as neutrons released from the fusion of the deuterium-tritium may react with the lithium deuteride in the fuel rod to form tritium, which may then fuse with the deuterium in the lithium deuteride, increasing the overall energy yield (see formulae 1 to 3 below).

In some embodiments, the fuel rod may be integral to the front portion of the charge liner. Alternatively, the fuel rod may be connected to the front portion of the charge liner by a joining technique, such as by an adhesive, brazing, soldering and/or welding, or by one or more bolts or screws.

Optionally, the inner surface of the one or more walls of the quench chamber may at least partially comprise radiation shielding and/or neutron reflector material. This may increase the amount of energy generated by ensuring that more energy is transferred from the emitted neutrons to the quench fluid. For example, an inner surface of the one or more walls of the quench chamber may be at least partially coated with graphite and/or beryllium.

It may be particularly important to provide radiation shielding and/or neutron reflector material in the quench chamber if the shaped charge contains nuclear fusion fuel. For example, the fusion of deuterium-tritium (D-T), which could be the most efficient nuclear fusion reaction, releases neutrons via the reaction:

D+T→He+n -(1)

These neutrons can carry around 80% of the fusion energy yield and can cause significant structural damage if not absorbed in the quench chamber. Other fusion fuels also release neutrons as by-products, including lithium deuteride (⁶LiD).

Optionally, the fluid in the quench chamber may at least partially comprise lithium. The lithium may react with neutrons to advantageously protect the structural integrity of the quench chamber and breed more tritium via the reactions:

⁶Li+n→T+He -(2)

⁷Li+n→T+He+n -(3)

Additionally or alternatively, as mentioned above, ⁶Li may be provided in the form of lithium deuteride in the fuel rod, which may lead to the reaction in formula (2).

In a second aspect of the present invention, there is provided a projectile suitable for use in the apparatus of the first aspect of the invention, wherein the projectile comprises a shaped charge comprising:
a charge liner having a front portion and a rear portion; an explosive material located adjacent to at least the rear portion of the charge liner; and a detonator operable to detonate the explosive material;
wherein the charge liner is at least partially filled by a pressurised fluid.

Optionally, the pressurised fluid may at least partially comprise a fusion fuel. The fusion fuel may comprise one or more of: deuterium-tritium (D-T); helium; helium-deuterium; and/or lithium deuteride (⁶LiD).

Optionally, a fuel rod may be connected to a front portion of the charge liner, wherein the fuel rod comprises a cavity configured to receive a fusion fuel.

In some embodiments, the cavity in the fuel rod may at least partially contain a pressurised lithium deuteride (⁶LiD) based fuel and the charge liner may at least partially comprise a pressurised deuterium-tritium based fuel.

Optionally, the projectile may comprise an elongate member having a first end and a second end. The shaped charge may be connected to the first end of the elongate member. In some embodiments, the elongate member may comprise one or more stabilising fins, e.g. two, three or four stabilising fins or at least one pair of stabilising fins.

Any embodiment of the fuel rod, or configuration of the shaped charge described herein in relation to the first aspect of the invention applies equally to the second aspect of the invention.

In a third aspect of the present invention, there is provided a power station for generating electrical energy, the power station comprising:
an apparatus according to the first aspect of the present invention;
at least one turbine in fluid communication with the at least one outlet of the quench chamber; and
at least one electrical generator operably connected to the at least one turbine; wherein, in use, gas emitted from the at least one outlet turns the at least one turbine, thereby driving the at least one electrical generator.

In some embodiments, the apparatus of the first aspect of the present invention may be retrofitted in an existing conventional (e.g. fossil fuel powered) power station.

The power station may also comprise at least one energy storage device, such as a battery, connected to each electrical generator. The energy released by each shaped charge will be intermittent and so the use of at least one energy storage device may help to provide a more continuous (i.e. on-demand) power supply.

In a fourth aspect of the present invention, there is provided a method of generating energy comprising the steps of:
providing a projectile comprising a shaped charge comprising a charge liner having a front portion and a rear portion, an explosive material located adjacent to at least the rear portion of the charge liner and a detonator operable to detonate the explosive material;
propelling the projectile towards a target located in a quench chamber, the quench chamber containing a quench fluid; and
before the projectile reaches the target, detonating the explosive material to collapse the charge liner, thereby generating a jet of particles which impacts the target, thereby releasing energy which heats the quench fluid causing a gas to be released from the quench chamber through an outlet, the outlet being in fluid communication with at least one turbine of a power station.

In some embodiments, the method may include igniting nuclear fusion of a fusion fuel contained in the charge liner and/or in a fuel rod connected to the front portion of the charge liner. The step of igniting nuclear fusion may be caused by the extreme pressures exerted by the impact of the jet of particles with the target, and/or by the pressures exerted during the formation of the jet of particles.

The step of propelling the projectile into the quench chamber may be repeated periodically, either at regular or irregular intervals. For instance, the method may be performed once or twice a day, as, if nuclear fusion is ignited, then this may be sufficient to reach a desired daily quota of output energy.

The method may also include storing at least a portion of the energy generated by the power station. This may be particularly advantageous if the method includes igniting nuclear fusion, as the energy generated intermittently by each shaped charge may be very large.

If the method includes the step of igniting nuclear fusion, then the method may further include the step of extracting one or more by-products of the fusion reactions from the quench chamber. For example, the target may be irradiated with neutrons or light nuclei (e.g. deuterium or tritium) which may form heavier elements. For example, if the target is made of one or more of steel, iron, or titanium, then precious metals such as gold, silver, platinum and/or palladium may be formed via neutron bombardment of the target.

Additionally or alternatively, there may be fusion fuel (e.g. tritium and/or deuterium) in the quench chamber which can be extracted and recycled for further fusion reactions.

The step of extracting the fusion by-products from the quench chamber may occur after a plurality of repetitions of the above method steps (i.e. after a plurality of shaped charges have been detonated). This may allow the by-products to build up inside the quench chamber to a level which is more easily extractible and/or more commercially viable to extract.

Optionally, the method may also include the initial step of assembling the shaped charge for use. This may include at least partially evacuating the charge liner and inserting a nuclear fusion fuel into the charge liner. The method may also include at least partially evacuating the quench chamber.

Optionally, assembling the shaped charge for use may include connecting a fuel rod to the front portion of the charge liner, wherein the fuel rod comprises a cavity at least partially containing a fusion fuel. The method may also include the steps of drilling the fuel rod to provide the cavity, and inserting the fusion fuel into the cavity.

The method may include pressurising the nuclear fusion fuel.

Embodiments of the invention will now be described, by way of example only, with reference to the accompanying drawings, in which:

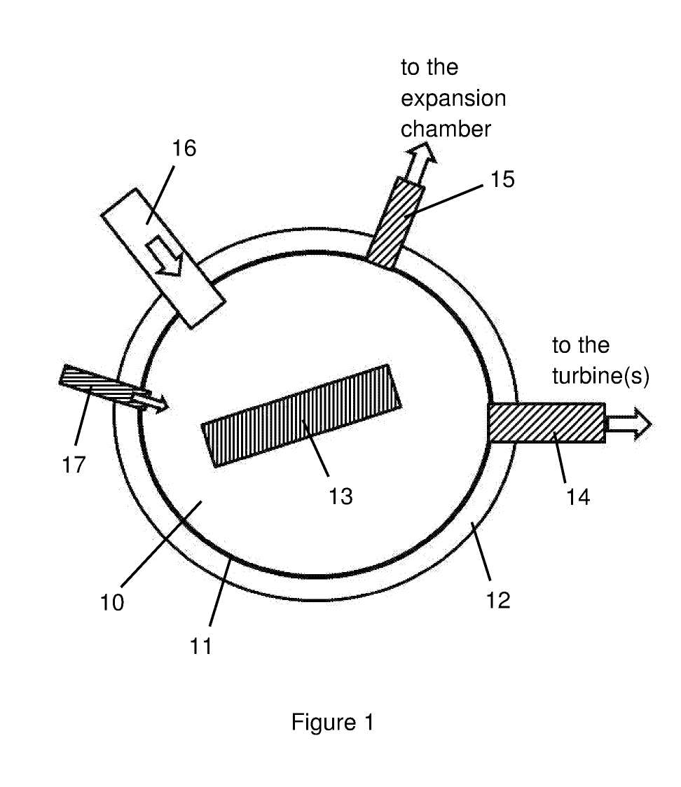

FIG. 1 shows a schematic diagram of an apparatus for generating energy according to embodiment of the invention;

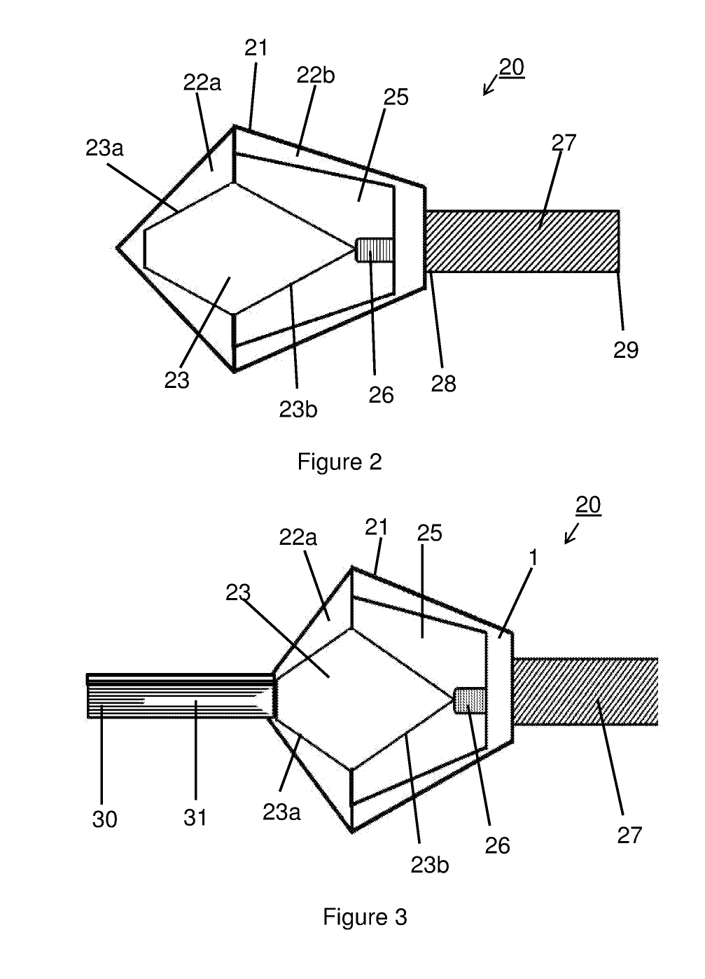

FIG. 2 shows a schematic diagram of a cross-section of a shaped charge according to an embodiment of the invention; and

FIG. 3 shows a schematic diagram of a cross-section of a shaped charge comprising a fuel rod according to an embodiment of the invention.

FIG. 1 shows a schematic diagram of an example of an apparatus for generating energy according to the invention. The apparatus comprises a quench chamber 10.

The quench chamber 10 does not have to be round or spheroidal and is not shown to scale.

The quench chamber 10 is at least partially filled with a quench fluid (not shown). Typically, the quench fluid may comprise, or consist essentially of, water. The quench chamber 10 may be at least partially evacuated to reduce the pressure inside the quench chamber 10. This may be advantageous to reduce the boiling temperature of the quench fluid.

The quench chamber 10 comprises a fluid inlet 17 which allows quench fluid (e.g. water) to flow into the chamber. The quench chamber 10 also comprises a fuel inlet 16. In use, a propulsion means (not shown) is operable to propel a projectile through the fuel inlet 16. The propulsion means may comprise a gun barrel.

A target 13 is located within the quench chamber 10. The target 13 is positioned in the path of a projectile propelled, in use, through the fuel inlet 16 into the quench chamber 10. In this example, the target 13 is made of one or more of steel, iron or titanium and has a thickness of at least 300 mm.

The quench chamber 10 comprises an inner wall 11 and an outer wall 12. The inner wall 11 is preferably formed of steel having a thickness of at least 200 mm; this may prevent the quench chamber 10 from being perforated, in use, by any deflected matter from the projectile 20 or the target 13.

The surface of the inner wall 11 may be coated at least in part with a neutron reflector material such as graphite and/or beryllium to improve the reflection of any neutrons emitted in the quench chamber 10. The outer wall 12 is at least partially formed of concrete or other materials suitable for absorbing thermal shocks.

In use, the quench fluid may at least partially boil due to energy transferred to the quench fluid by the projectile and/or the impact of the projectile with the target 13. Hence, a gas (e.g. steam) may be produced in the quench chamber 10. Such a gas is emitted from the chamber 10 via the outlet 14 which is in fluid communication with one or more turbines (not shown) of a power station (not shown). In some embodiments more than one outlet 14 may be provided. As in a conventional power station, the turbines drive at least one electrical generator to generate electrical energy.

If the pressure within the quench chamber 10 exceeds a maximum safety threshold then the quench fluid can be at least partially released from the quench chamber 10 via an emergency outlet 15. The emergency outlet 15 is in fluid communication with an expansion chamber (not shown). The emergency outlet 15 may comprise a bursting disc which is operable to rupture when the pressure in the quench chamber 10 reaches a predetermined threshold, thereby allowing fluid to flow through the emergency outlet 15. Alternatively, the emergency outlet 15 may be automatically opened by a control unit if the pressure inside the quench chamber 10 reaches a predetermined threshold.

FIG. 2 shows a schematic diagram of a longitudinal cross-section of a projectile 20 for use with an apparatus for generating energy of the present invention, for example the apparatus in FIG. 1.

The projectile 20 comprises a shaped charge 21. The shaped charge is contained within an outer housing having a front portion 22a and a rear portion 22b. The housing 22a, 22b may be shaped to improve the aerodynamic properties of the projectile 20. The front portion 22a and the rear portion 22b of the housing may be integral or contiguous, for example the housing may be moulded as a single continuous piece.

The rear portion of the housing 22b is connected to a first end 28 of an elongate member 27. In use, a propulsion means (not shown) applies a propulsion force to a second end 29 of the elongate member 27, in order to propel the projectile 20, e.g. through the fuel inlet 16 and into the quench chamber 10 (see FIG. 1).

Contained within the housing 22a, 22b of the shaped charge 21 is a hollow charge liner 23, wherein the charge liner 23 comprises a front portion 23a and a rear portion 23b. In this embodiment the charge liner 23 is formed of copper and/or tantalum. Optionally, the housing 22a, 22b may be formed of the same material as the charge liner 23.

The charge liner 23 in FIG. 2 is a conical charge liner. The front portion 23a of the charge liner 23 comprises a tip and the diameter of the front portion 23a of the charge liner 23 increases from the tip towards to rear portion 23b. The diameter of the rear portion 23b of the charge liner 23 decreases along its length, such that its narrowest point is furthest from the front portion 23a of the charge liner 23. The front portion 23a and the rear portion 23b may be integral, or they may be connected by a joining technique such as welding, adhesive or brazing, or by one or more bolts or screws.

An explosive material 25 at least partially surrounds the rear portion 23b of the charge liner 2. In some embodiments, the explosive material 25 may comprise one or more of Octogen, Octol, Amatol, or a polymer-based explosive material. A detonator 26 is located adjacent to the rear portion 23b of the charge liner 23. Thus, in use, the explosive material 25 is detonated from behind the rear portion 23b to collapse the walls of the rear portion 23b of the charge liner along the central axis. This should ensure that the explosive material's energy is correctly focused to form a jet of particles from the colliding walls of the charge liner 23.

In use, it is important that the detonator 26 detonates the explosive material before the projectile 10 impacts the target 13.

In some embodiments, multiple detonators 26 may be provided adjacent to the rear portion 23b of the charge liner. The detonator(s) 26 may be triggered remotely (e.g. via an electromagnetic signal emitted from a control unit) and/or the detonator(s) 26 may be triggered by a trigger (e.g. a piezoelectric trigger) provided on the front of the housing 22a or the front portion 23a of the charge liner 23 (not shown).

The charge liner 23 may contain air, or another fluid, which may be pressurised (i.e. have a higher average pressure than standard atmospheric pressure). In some embodiments, the charge liner 23 may be at least partially filed with a nuclear fusion fuel, such as deuterium-tritium and/or lithium deuteride. The fusion fuel is preferably highly pressurised to the maximum pressure that can be withstood by the charge liner 23 before leakage or structural damage occurs.

Every joint or connection in the charge liner 23 should be hermetically sealed with a suitable fluid-tight sealant. The charge liner 23 may be at least partially evacuated before inserting the fusion fuel into the charge liner 23. For example, the air within the charge liner 23 may be at least partially removed using a vacuum pump or a hypodermic needle. The charge liner 23 may comprise a one-way valve (e.g. no return valve) or a rubber septum through which the pump or needle may be inserted to evacuate the charge liner 23. The fusion fuel may then be inserted into the charge liner 23 through the valve or septum using the pump or a needle.

Another example of a projectile 20 according to the present invention is shown in FIG. 2, wherein the features which are common to both FIG. 1 and FIG. 2 are labelled with the same reference numerals.

The projectile 20 in FIG. 2 comprises a fuel rod 30 connected to the front portion 23a of the charge liner 23. In other examples, the fuel rod 30 may be integral to the front portion of the housing 22a or to the charge liner 23.

The fuel rod 30 comprises a cavity 31 which is drilled into the fuel rod 30. In this example the fuel rod comprises a steel rod having a length of around 300 mm and a diameter slightly larger than the tip of the front portion 23a of the charge liner. The cavity 31 extends no more than 100 mm into the rod. However, other materials and length of rod and/or cavity are possible within the scope of the present invention.

The cavity 31 contains a fusion fuel which in this example is lithium deuteride. Preferably, the fusion fuel is pressurised. As such, the rod 30 provides booster fuel for the reaction of the charge liner 23, as neutrons released from the fusion of the fuel within the shaped charge 23 may react with the lithium deuteride in the cavity 31 to form tritium, which provides more fuel for the fusion reaction in the shaped charge 23.

In use, the rod 30 may be trapped between the target 13 and the jet formed by the collapsed charge liner 23. The pressure exerted during impact with the target 13 may be sufficient to at least partially ignite nuclear fusion of the material in the cavity 31 of the fuel rod 30 and any fusion fuel contained in the charge liner 23.

Various modifications of the specific example embodiments disclosed herein will be apparent to the person skilled in the art without departing from the scope of the invention.

1-33. (canceled)

34. An apparatus for generating energy suitable for use in an electrical power station, comprising:
a quench chamber, the quench chamber containing a quench fluid, the quench chamber having a fuel inlet and an outlet in fluid communication with at least one turbine of the power station;
a target located within the quench chamber; and
a propulsion means operable to propel a projectile towards the target;
wherein the projectile comprises a shaped charge comprising a charge liner having a front portion and a rear portion, an explosive material located adjacent to at least the rear portion of the charge liner and a detonator operable to detonate the explosive material;
wherein, in use, the propulsion means propels the projectile through the fuel inlet towards the target and, before the projectile reaches the target, the detonator detonates the explosive material generating a jet of particles which impacts the target, thereby releasing energy, which heats the quench fluid causing a gas to be released through the outlet, which gas then drives the at least one turbine.

35. The apparatus of claim 34, wherein the charge liner is a conical charge liner, optionally wherein the charge liner is formed of any one or more of: copper; tungsten; tantalum; and molybdenum.

36. The apparatus of claim 34, wherein the quench fluid comprises, or consists essentially of, water, such that the when the quench fluid is heated steam is generated which is emitted through the outlet.

37. The apparatus of claim 34, wherein the quench chamber comprises an emergency outlet in fluid communication with an expansion chamber, wherein the emergency outlet is operable to allow quench fluid to flow out of the quench chamber into an expansion chamber if the pressure inside the quench chamber exceeds a predetermined value, optionally wherein the emergency outlet comprises a bursting disc configured to rupture when the pressure inside the quench chamber exceeds a maximum safety threshold.

38. The apparatus of claim 34, wherein the quench chamber is at least partially evacuated to lower the air pressure inside the quench chamber.

39. The apparatus of claim 34, wherein the propulsion means is a chemical propellant or a magnetic or electric propulsion means.

40. The apparatus of claim 34, wherein the explosive material comprises any one or more of: a polymer-bonded explosive; Octogen (HMX); Octol; Amatol; TNT; an explosive nitrosamine; and powdered aluminium.

41. The apparatus of claim 34, wherein the target has a thickness of at least 400 mm and, optionally, wherein the target is formed of any one or more of: steel; iron; and titanium.

42. The apparatus of claim 34, wherein the charge liner is at least partially filled by a pressurised fluid, optionally wherein the pressurised fluid comprises a nuclear fusion fuel, optionally wherein the nuclear fusion fuel comprises deuterium-tritium (D-T).

43. The apparatus of claim 34, further comprising a fuel rod connected to the front portion of the charge liner, wherein the fuel rod comprises a cavity containing a fusion fuel, optionally wherein the cavity in the fuel rod at least partially contains lithium deuteride (⁶LiD), optionally, wherein the fuel rod comprises a metal rod having a length of up to or at least 100 mm, up to or at least 200 mm and/or up to or at least 400 mm and/or the cavity has a length of up to 100 mm or up to 200 mm.

44. The apparatus of claim 34, wherein the quench chamber comprises one or more walls, wherein at least a portion of the one or more walls is formed of one more of steel, iron or titanium and has a thickness of at least 200 mm, optionally wherein an inner surface of the one or more walls of the quench chamber at least partially comprises radiation shielding and/or neutron reflector material, optionally wherein the inner surface of the one or more walls of the quench chamber is/are at least partially coated with graphite and/or beryllium.

45. The apparatus of claim 44, wherein the quench chamber comprises at least one outer wall substantially surrounding the quench fluid, wherein the at least one outer wall comprises concrete or other material suitable for withstanding thermal shocks.

46. A power station for generating electrical energy, the power station comprising:
the apparatus of claim 34;
at least one turbine in fluid communication with the at least one outlet of the quench chamber; and
at least one electrical generator operably connected to the at least one turbine;
wherein, in use, gas emitted from the at least one outlet turns the at least one turbine, thereby driving the at least one electrical generator.

47. The power station of claim 46, further comprising at least one electrical storage device connected to each electrical generator.

48. A projectile suitable for use in an apparatus according to claim 34, the projectile comprising a shaped charge comprising:
a charge liner having a front portion and a rear portion;
an explosive material located adjacent to at least the rear portion of the charge liner; and
a detonator operable to detonate the explosive material;
wherein the charge liner is at least partially filled by a pressurised fluid.

49. The projectile according to claim 48, wherein the pressurised fluid comprises a fusion fuel, optionally wherein the fusion fuel comprises one or more of: deuterium-tritium (D-T); helium; helium-deuterium; and/or lithium deuteride (⁶LiD).

50. The projectile according to claim 48, further comprising a fuel rod connected to the front portion of the charge liner, wherein the fuel rod comprises a cavity containing a fusion fuel, optionally wherein the cavity in the fuel rod at least partially contains lithium deuteride (⁶LiD).

51. A method of generating energy comprising the steps of:
providing a projectile comprising a shaped charge comprising a charge liner having a front portion and a rear portion, an explosive material located adjacent to at least the rear portion of the charge liner and a detonator operable to detonate the explosive material;
propelling the projectile towards a target located in a quench chamber, the quench chamber containing a quench fluid; and
before the projectile reaches the target, detonating the explosive material to collapse the charge liner, thereby generating a jet of particles which impacts the target, thereby releasing energy which heats the quench fluid causing a gas to be released from the quench chamber through an outlet, the outlet being in fluid communication with at least one turbine of a power station.

52. The method of claim 51, further comprising the step of igniting nuclear fusion of a fusion fuel contained in the charge liner and/or in a fuel rod connected to the front portion of the charge liner, optionally further comprising extracting one or more by-products of the fusion reactions from the quench chamber, optionally further comprising storing at least a portion of the energy generated by the power station.

53. The method of claim 51, wherein the step of propelling the projectile towards the target is repeated periodically, either at regular or irregular intervals.
